(19) United States
(12) Patent Application Publication
(10) Pub. No.: US 2006/0173778 A1
(43) Pub. Date: Aug. 3, 2006

(54) Enterprise billing system for medical billing

(76) Inventors: Mark Robert Lipsky, Waunakee, WI (US); Brandon Jon Baldock, Fitchburg, WI (US); Tin-Hang Andrew Ma, Fitchburg, WI (US); Michael Paul Kulas, Madison, WI (US); Kin Man Yau, Madison, WI (US); Herman Harjono, Fitchburg, WI (US); Biao Shou, Madison, WI (US); Kiran Subhash Joshi, Madison, WI (US); Meiskye Untono, Fitchburg, WI (US)

Correspondence Address: QUARLES & BRADY LLP, 411 E. WISCONSIN AVENUE, SUITE 2040, MILWAUKEE, WI, 53202-4497, US

(21) Appl. No.: 11/048,528

(22) Filed: Feb. 1, 2005

(51) Int. Cl. G06Q 40/00

(52) U.S. Cl. 705/40

(57) ABSTRACT

An enterprise medical billing system receives patient identifying and charge information from a variety of sources, associates the charge data with a guarantor, provides a consolidated statement to the guarantor, and allocates portions of a received payment to the variety of sources based on a series of configurable payment rules.

### BACKGROUND OF THE INVENTION

The present invention relates to medical billing systems and in particular to an enterprise billing system for centrally collecting medical charge information, producing a central patient statement, collecting, and distributing payment to the various business entities.

Hospitals and physicians deliver healthcare cooperatively, but as separate business entities. A patient staying in a hospital will typically receive separate bills from a treating physician, from the hospital, and from other sources as providing care may dictate. A physician's charges may cover the physician's professional services, the hospital's may cover use of hospital resources including rooms, equipment, and supplies, and other sources may include independent services run within the hospital, such as a home health care organization run by an independent entity. When separate physicians render services during a hospital stay, for example, a surgeon, an anesthesiologist, and a radiologist, each physician may generate their own charges. Even when physicians and hospitals work as a single business entity in an integrated delivery network, separate billing systems may be used to provide, for example, hospital charges, such as fees for a room, and professional charges, such as physician services.

The various bills produced for services performed during a medical service are difficult both for consumers, who have difficulties understanding the information on statements budgeting for, tracking, and controlling their expenses, and for the medical service providers, who require a significant staff to handle the paperwork associated with sending statements, collecting payments from patients, and distributing the payments to the appropriate parties. For these reasons, systems have been developed to consolidate the statements for medical services. Known, for example, are “clearinghouses” which either electronically or manually collect statements from medical service providers and then attempt to consolidate the statements by matching statement data to the guarantor. These systems, therefore, compare identifying information such as the name, address, phone number, or social security number for the guarantor to be billed, and consolidate the statements when a “match” is found. While this procedure minimizes paperwork for the consumer, it actually increases the amount of work required and expenses incurred by the medical services provider to produce the statement. Furthermore, because keyed data, data structure, and terminology may vary between the various billing computers used to produce the statements, the resultant bills can be either incomplete, incorrect, or include charges which should have been billed to another party. Additionally, these clearinghouse systems often do not have access to billing background information and data, and therefore cannot answer questions raised by consumers regarding the bills, adding yet another level of complexity to the process for consumers.

### BRIEF SUMMARY OF THE INVENTION

The present invention provides a medical billing system which simplifies the billing process both for medical service providers and for consumers by compiling a single statement for all medical practices in an enterprise, and allocating funds from payments received to the various practices based on a plurality of stored rules.

In one aspect of the invention, the medical billing system includes a plurality of charge sources creating charges, and at least two billing programs receiving charge data to generate bills and receiving posted payments for the bills. An enterprise registration system associates each charge with a known guarantor. A consolidated statement program receives charge data from each of the at least first and second billing programs and produces a single billing statement for the known guarantor. A payment posting program receives payment from the known guarantor and allocates the payment to each of the at least first and second billing systems based on a set of rules stored in a rule engine.

The rules in the rule engine can be user-configurable, and also can allocate payments based on at least one of an oldest outstanding bill first rule, a predefined allocation rule, and a user selectable payment rule.

The medical billing system can also include a charge router for routing charges among the billing computers. The charge router receives charge data from charge sources which can include clinical, lab, pharmacy, service, and supply charges. A charge router determines which billing system the charge should be assigned to, translates the charge data into format useable by the each of the at least first and second billing systems, determines which of the first and second billing computers should receive the charge, and forwards the charge to the selected computer.

The payment posting program can further include both a guarantor payment posting program and an insurance payment posting program. The guarantor payment posting program can allocate shares of a payment received from the known guarantor to the at least first and second billing systems as determined by the rule engine and the insurance payment posting program can allocate shares based on rules or instructions provided by the insurance company.

The enterprise registration program can place the guarantor in a queue for billing when charges are incurred against an account in the name of the guarantor.

In another aspect of the invention, a medical billing system for a medical enterprise comprising at least two medical practices having independent billing computer systems is provided. The medical billing system includes at least one registration computer for registering patient visits and recording charges for each of the medical practices, an enterprise computer system storing guarantor data and coverage data for each of the medical practices, and at least one common data link connecting the registration system computers, the independent billing computer systems, and the enterprise computer system. The enterprise computer system communicates with each of the registration computers and independent billing computer systems and is programmed to receive patient identifying data and charge data from the charge sources, associate a guarantor with the patient identifying data and charge data for each patient visit, and route appropriate charges to each of the independent billing systems. The enterprise computer system is further programmed to consolidate the charges from each of the independent billing systems into a single statement for each guarantor, and to allocate a payment received from the guarantor to each of the independent billing systems based on rules provided in a rule engine.

The medical billing system can further be programmed to route the charges received at the registration computer to the responsible medical provider computer which can be, for example, at least one of a hospital, a physician office, and a clinical computer.

The medical billing system can also be programmed to provide an insurance claim to an insurance company and allocate funds from a payment from the insurance company to each of the medical practice billing systems. The medical billing system can also provide a billing queue identifying the guarantors who have outstanding charges in a guarantor account.

In another aspect, the present invention provides a method for producing a single statement for medical expenses incurred from at least two medical practices having independent billing computer systems. The method comprises the steps of identifying a guarantor for the medical charges as the charges are incurred, associating the identified guarantor with the incurred charges and guarantor account data for each of the independent billing computer systems, associating the identified guarantor with a billing cycle queue when the charges are incurred, and routing each charge incurred against the identified guarantor to one of the independent billing computer systems based on the type of charge. Once the charges are incurred, the accounts associated with the identified guarantor are periodically retrieved from the billing cycle queue, and a single statement for the guarantor is compiled. Upon receipt of payment for the statement, payments are allocated to each of the independent billing computer systems based on rules. These rules can be either pre-established or user-configurable.

In still another aspect of the invention, a method is provided for producing a single statement for medical expenses incurred from at least two medical practices having independent billing computer systems. The method comprising the steps of providing a database identifying a guarantor for a patient and account data for the guarantor for each of the independent billing computer systems, and associating the identified guarantor with the incurred charges and guarantor account data for each of the independent billing computer systems as charges are incurred. Periodically, a single statement is compiled for the guarantor based on charges incurred. Upon receipt of payment from the guarantor, payment is allocated to each of the independent billing computer systems based on the type of charges incurred.

These and other aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE DRAWINGS

FIG. 1 is a physical block diagram of a billing system of the present invention as implemented in one embodiment as a set of computers connected by a common communication network;

FIG. 2 is a logical block diagram of the billing system of FIG. 1;

FIG. 3 is a simplified representation of a billing queue and guarantor charge data structure used in the present invention;

FIG. 4 is a flow chart illustrating the consolidated statement program of FIGS. 1 and 2; and

FIG. 5 is a flow chart illustrating the guarantor payment posting program of FIG. 2.

### DETAILED DESCRIPTION OF THE PREFERRED EMBODIMENT

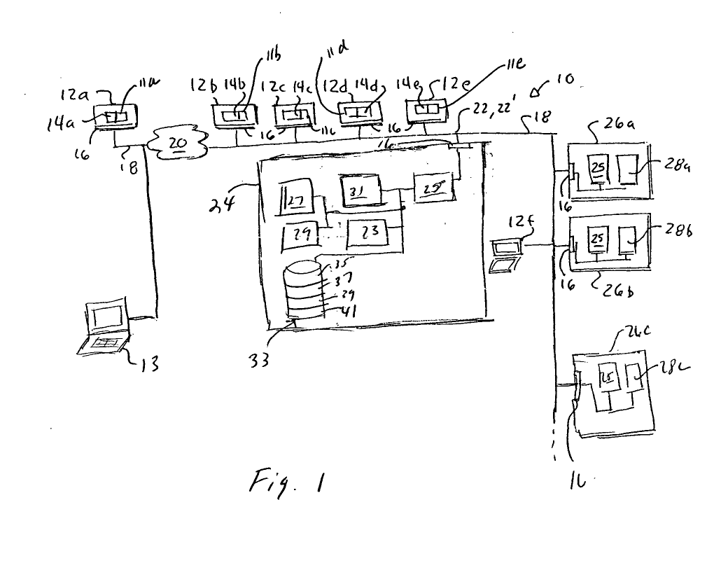

Referring now to FIG. 1, a medical billing system 10 may include a number of billing terminals 12a through 12d, each being a computer terminal associated, for example, with a hospital service area, a medical laboratory, and/or a professional office of a physician. The billing terminals can be stand-alone personal computers or workstations connected to a network, or dummy terminal for data entry.

Each of the terminals 12a through 12d may execute a registration program 11a through 11d for registering patient data, and/or submitting program 14a through 14d such as provides a graphical interface through which a user may enter charge data associated with a medical procedure, order, or other service. The submitting programs 14a through 14d are therefore sources for charges which forward the charge data to billing programs 28a and 28b such as may be held on remote billing computers 26a and 26b executed by processors 25. Generally, each of the submitting programs 14a through 14d is associated with at least one billing program 28a or 28b such as commonly may be either a hospital billing system or professional billing program to provide charge data to the appropriate billing system.

The terminals 12a through 12d each include network interfaces 16 allowing them to connect to a network 18, for example, an Ethernet network, also communicating with the billing computers 26a and 26b through interfaces 16. The network 18 is of arbitrary topology provided that it connects each of the terminals 12a through 12d to a common logical point 22 and each of billing computers 26a and 26b to a common logical point 22′ (in this case the same physical point). Generally, the network 18 may include bridges, connections over the Internet 20, wireless links, dedicated lines, and other well known methods of data communication.

The common logical points 22 and 22′ communicate with at least one network interface 16 of an enterprise billing computer 24 holding an enterprise billing system including an enterprise registration program 31, charge router program 27, at least one payment posting program 29, and a consolidated statement program 23 executed by one or more processors 25. The enterprise billing computer 24 further includes memory storage 33 for storing a patient database 35, coverage data 41, and account data for identifying a guarantor account for the billing computers 26a and 26b, here shown as the guarantor accounting data 37 and guarantor hospital accounting data 39, respectively. It will be apparent that the database can be expanded to include guarantor account data for additional billing computers 26, as necessary. As will be described in more detail below, the enterprise billing computer 24 receives patient registration, charge, and payment data from the terminals 12a through 12d over the network 18, processes that charge data, and distributes charge data and payments through network 18 to billing computers 26a and 26b. Other terminals 12f may also be connected to the network 18 or directly to enterprise billing computer 24 to provide communications between the enterprise billing computer 24, and remote billing computers 26a and 26b as will be described. The billing computer 24 can also be accessed by user computers 13 through, for example, a secure link to the Internet 20 or other network systems to view statements and/or post payments as described more fully below. Furthermore, it will be apparent that the enterprise billing computer 24 may exist as a single server or multiple computers linked together.

It will be understood to those of ordinary skill in the art that the physical structure shown may be readily varied. Additional billing computers 26 and/or billing programs 28 may be added and the physical network may be modified to provide the necessary communication using single or multiple links as will be understood to those of ordinary skill in the art. Terminals 12 and submitting programs 14 may be added or removed. Multiple programs may run on a single computer and other similar changes in how the programs are distributed among hardware may be made without fundamentally affecting the operation of the invention.

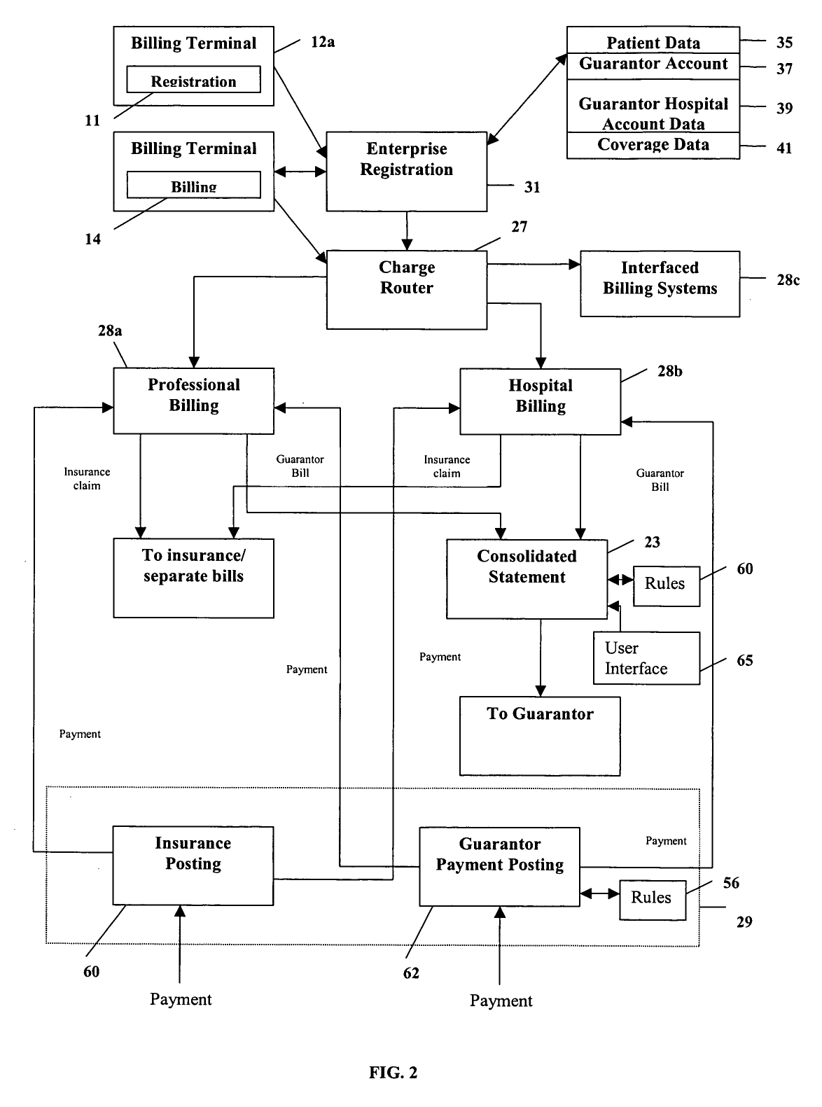

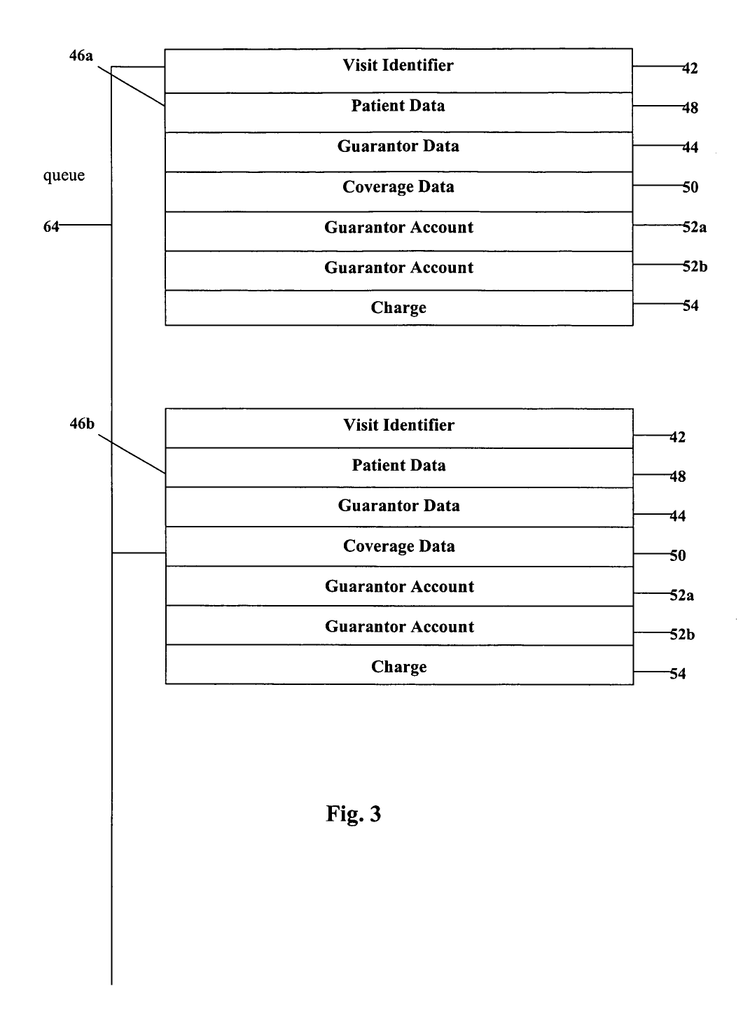

Referring now also to FIG. 2, a flow chart illustrating the billing process using the enterprise billing system 24 described above is shown. When a patient enters a medical clinic, hospital, laboratory, or other medical facility, data for identifying the patient guarantor, account, and insurance coverage (if applicable) responsible for incurred charges are entered into one of the billing terminals 12a through 12d executing registration software 11. The data received from the billing terminal 12a is transmitted to the enterprise billing computer 24 and particularly to the enterprise registration program 31 which, referring now also to FIG. 3, provides a unique visit identification number 42 and, based on the received patient data, retrieves data from the databases stored in memory component 33 to provide a linked data structure 46a including the data necessary for all of the connected billing systems to obtain payment for the services provided. The retrieved data includes patient data 48 from the patient database 35 which can include the name, address, phone number, and social security number of the patient, and further, the identity and related identifying information for the guarantor 44 responsible for payment of the patient's accounts. The guarantor 44 can be, for example, a parent or guardian, the patient themselves or some other third party, such as an employer responsible for payment of the patient's expenses. Once the guarantor 44 is identified, insurance or other coverage data 50 for the identified guarantor 44 is retrieved from the coverage database 41 and guarantor account data 52a and 52b are retrieved from the guarantor account database 37 for the professional billing system 28a and the guarantor account database 39 for the hospital billing computer 28b, respectively. Although not shown, guarantor account data can also be associated with accounts used by interfaced billing systems 28c. Each of these billing systems can be of different types, structures, or configurations, and can include different billing systems. The visit identification data 42, patient data 48, guarantor data 44, coverage data 50, and guarantor account data 52 are linked in the charge data structure 46a which therefore includes all necessary data for billing charges to the guarantor from any of the billing systems linked to the enterprise billing computer 24.

Charges incurred at the medical facility are then entered through any of the billing terminals 12a-12d which, as described above, can operate any number of submitting programs 14. The charge data 54 is linked by the enterprise registration system 31 with the charge data structure 46a associated with the visit 42. The charges associated with the data structure 46a can then be routed to the appropriate billing system 28a, 28b, or 28c. Routing can be performed manually, through dedicated interfaces to various billing systems 28a, 28b, or 28c, as shown, through a dedicated charge router program 27 such as the charge router program described more fully in U.S. patent application Ser. No. 10/950,882 entitled “Universal Charge Routing System for Medical Billing” filed on Sept. 27, 2004, which is hereby incorporated herein by reference for its description of such a system. The charge router 27 receives the charge data 54 in charge data structure 46a, determines whether the charge is a professional charge, a hospital charge, or other type of charge, and converts the charges 54 entered through the terminals 12 through a series of translators to a format which can be used by the professional billing system 28a, the hospital billing system 28b or any other of at least one interfaced billing systems 28c, each of which typically require a different, specific format. Charges 54 and associated data in charge data structure 46a are distributed by the charge router 27 to the appropriate billing system and the guarantor 44 of the accounts that have incurred charges is placed on a billing statement queue 64 for billing purposes. As charges are entered into the billing system 12a, subsequent data structures 46a, 46b, etc. are added to the queue 64 which provides a list of accounts which have incurred charges and need to be billed, as described below. Furthermore, the accounts can be accessed by the guarantor through a secure user interface 65, which can be, as described above with reference to FIG. 1, connected to a computer 13 connected to the internet or other network service or communication links. The user interface 65 allows access to the account data for the user to both view the account and post electronic payments.

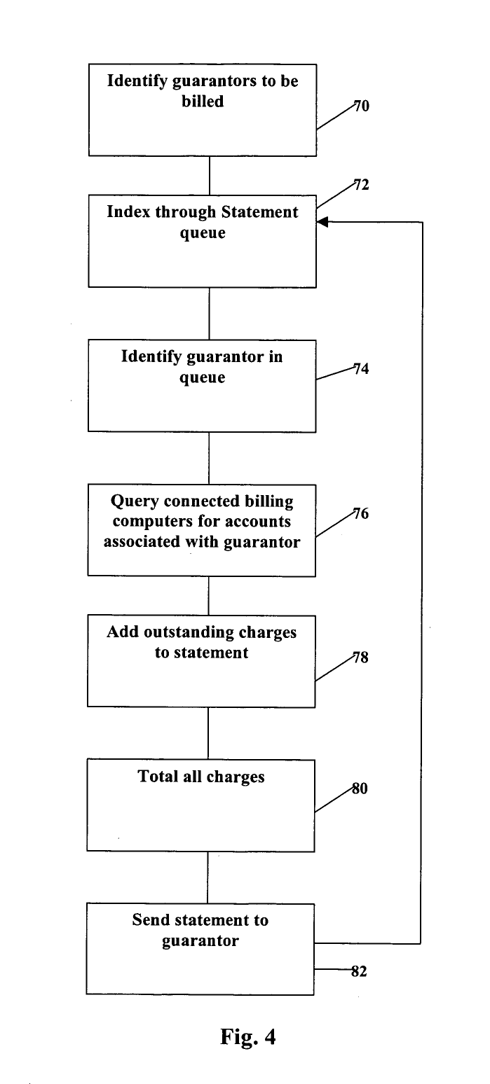

Referring now also to FIG. 4, to create statements for billing the guarantor 44, the consolidated statement program 23 retrieves the queue 64 of guarantors 44 and determines which guarantors 44 are to be billed in the present billing cycle based on a series of rules retained in a rule engine 60. The rules can, for example, cause statements to be issued based on a “drop cycle” billing in which guarantors 44 are billed whenever new activity occurs on their accounts and then subsequently in a predetermined time frame thereafter until the accounts are paid. Alternatively, guarantors 44 can be billed based on alphabetical or numerical cycles, based on financial classes (i.e. all guarantors covered by Medicare, by a defined insurance group, etc.), or using a combination of any of these methods, or in other ways which will be apparent to those of skill in the art. These rules can be pre-established, or configured by a user as desired.

Initially, therefore, the consolidated billing program 23 determines which guarantors 44 are to be billed based on the rules (step 70). The program 23 then indexes through the statement queue (step 72) to identify the guarantors' having outstanding accounts (step 74), and then queries each connected billing system (step 76) for accounts 56a and 56b associated with the selected guarantors 44. Once the account data is retrieved, the consolidated statement program 23, combines the unpaid charges 54 associated with each account 56a and 56b from each of the connected billing systems into a statement (step 78), and calculates a total for the guarantor 44 (step 80) to produce a single statement containing all charges which can then be forwarded to the guarantor 44 for payment (step 82). The single statement can provide varying levels of detail regarding the charges associated with each identified visit 42 along with the total amount owed. Although indexing through the statement queue, as described above, is one way of determining which guarantors are to be billed, it will be apparent to those of ordinary skill in the art that various other methods could also be used. For example, when charges are incurred a flag could be set for the account, or various other methods could be used.

Referring again to FIG. 2, for full recovery of the charges for the medical services provided, a claim must also be sent to the insurer or other third party such as Medicare or Medicaid identified in the coverage database 41 associated with the guarantor 44. While, due to the linked data in charge data structures 46, it is possible to combine the insurance claims into a single statement, as described above with respect to the consolidated statement program 23, insurance companies typically require separate bills from the professional billing 28a and hospital billing 28b system and these charges are therefore billed separately. Therefore, the professional billing system 28a and hospital billing system 28b typically each provide a separate statement and forward the statement directly to the insurer or other third party guarantor. As necessary, the billing systems 28a, 28b, and 28c may also determine secondary or tertiary coverages based on data in the coverage database 41 and provide statements to all necessary parties.

Payments received from the insurer and guarantor are provided to the payment posting program 29 which, as shown here, may include both an insurance payment posting program 60 and a guarantor posting program 62. The insurance payment posting program 60 allocates money from insurance payments to accounts associated with the various medical practices in the system through the billing systems 28a, 28b, and 28c. The disbursement of these payments is typically defined by the insurance company making the payment, and the payment from the insurer therefore may include codes and/or other data for directing payment between the hospital billing system, the professional billing system, or other interfaced billing systems. Rules, however, can also be provided to customize the disbursement of insurance payment.

With respect to the guarantor payment posting 62, a series of customizable rules are provided in a rule engine 56 in the payment posting program 29 defining how received funds are to be allocated among the hospital and professional billing computers 28a, 28b, and/or interfaced billing systems 28c described above. The rule engine 56 can, for example, be customized by the user to direct payment to the oldest outstanding balance from any billing system connected to the enterprise billing program 24. Alternatively, the rule engine 56 can provide a hierarchical structure defining an order of payment for each of the attached billing systems, and selectively pay the oldest outstanding balance in the selected order. The rule engine 56 may, alternatively, pay equal portions of the received payment to all systems connected to the enterprise billing system 24 for which payment is owed, or assign a percentage of the payment to the account based on the outstanding amount owed to each of the billing systems. Alternatively, a pre-selected percentage can be associated with each connected system 28a, 28b, 28c and the payment can be posted based upon the pre-selected percentage. As an example, rules can be structured such that 60 percent of the payment is paid to the professional billing system 28a and 40 percent to the hospital billing system 28c. An “open payment” option can also be provided to allow guarantors 44 to identify which medical practice the payment is intended for. The “open payment” concept is useful, for example, to allow consumers to pay the outstanding balances for some services, while disputing bills associated with another service. Various other methods for allocating funds among the accounts will be apparent to those of skill in the art.

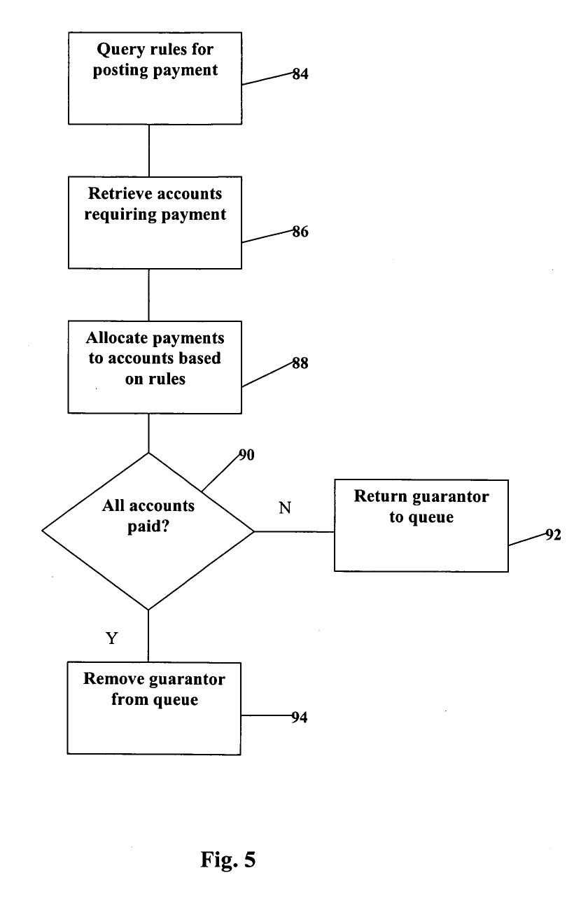

Referring now also to FIG. 5, when a payment is received from a guarantor 44, the guarantor payment posting program 62 initially determines the rules that apply to the payment (step 84) and then determines which accounts associated with the guarantor 44 have outstanding balances (step 86), and allocates payment to the accounts based on the rules in the rule engine 60 (step 88). The consolidated statement program 23 then determines whether the outstanding balance in each account has been paid, or whether additional payments need to be made (step 90). If all of the accounts are cleared, the guarantor 44 is removed from the queue 64 (step 94). If not, the guarantor 44 is retained in the queue 64 to await the next billing cycle (step 92).

The features of the enterprise billing system described above may be implemented on general purpose computers as programs stored in a memory and operating on data received stored in memory as communicated through standard computer input and output circuits. The system can also be implemented on a distributed network comprising any number of computers. It will be understood however, that some or all of the features of the present invention may also be implemented as dedicated circuitry such as applications specific integrated circuits or as firmware in specialized controllers or the like.

The enterprise billing system described above provides a number of advantages over prior art medical billing systems. First, a single statement of outstanding balances is provided to the consumer, thereby simplifying the process of handling and tracking payments and charges for the consumer. As a single statement is sent and a single payment is received, the efficiency of the billing and collecting processes is significantly improved, and overhead is decreased. Furthermore, when third party collectors are required to collect outstanding balance information, all of the data required for a single guarantor, including all bad debt, can be easily accessed. Tools can also be provided for increasing the efficiency of debt collection operations, including the ability to provide a single follow-up letter for all debt. Furthermore, tools which allow tracking of payment attempts can also be provided. These tools can, for example, track the number of letters sent or telephone calls made to collect from a given guarantor, or be used to provide a single payment plan for debt.

Furthermore, since insurance payments are received through a consolidated posting program, insurance payments are allocated through a single interface, preventing the possibility of over-allocating the payment to multiple practices, or under-allocating the payment causing the creation of unresolved funds.

Additionally, the present invention provides an improved interface for customer service. Since all data can be accessed from a single location, a customer service representative can provide a patient or guarantor with all necessary data regarding statements, including where the costs were incurred, when payment is required, payment history, and registration data including, for example, insurance coverage data. This data can also be used in order to provide a payment plan for a guarantor for repayment of balances in different medical practices. In lieu of a customer service representative, this information can also be provided on-line, where it can be accessed by the guarantor or patient through a secure connection.

Although a specific computer hardware and software system has been described above, it will be apparent that a number of variations can be made within the scope of the invention. For example, although the consolidation of charges is shown as a step provided after the charges are distributed to the individual billing computers, it will be apparent that charges could be consolidated at various stages of the process and then distributed to the billing computers. Other variations in the flow of data as well as the hardware and software components described will be apparent to those of skill in the art.

It is specifically intended that the present invention not be limited to the embodiments and illustrations contained herein, but include modified forms of those embodiments including portions of the embodiments and combinations of elements of different embodiments as come within the scope of the following claims.

We claim:

1. A medical billing system for receiving charges from a plurality of charge sources and producing a consolidated statement for charges incurred for at least two billing programs, the medical billing system comprising:
an enterprise registration system for associating charges with a known guarantor and forwarding the charge data and known guarantor to the billing programs;
a consolidated statement program for receiving charge data from each of the at least first and second billing programs and for producing a single billing statement for the known guarantor; and
a payment posting program receiving payment from the known guarantor and allocating the payment to each of the at least first and second billing systems based on rules stored in a rule engine.

2. The medical billing system of claim 1 wherein the enterprise registration system assigns a unique visit identifier to each patient visit and associates stored data with the unique visit identifier to identify the patient, the guarantor, and account data for each of the at least first and second billing system.

3. The medical billing system of claim 1 wherein the rule engine allocates payments based on at least one of an oldest outstanding bill first rule, a predefined allocation rule, and a user selectable payment rule.

4. The medical billing system as defined in claim 1, further comprising a charge router for receiving charge data from the enterprise registration system, determining which of the first and second billing computers should receive the charge, translating the charge into a format used by the selected billing system and forwarding the charge to the selected billing system.

5. The medical billing system as defined in claim 1 wherein the payment posting program comprises at least one of a guarantor payment posting program and an insurance payment posting program.

6. The medical billing system as defined in claim 1, wherein the guarantor payment posting program allocates shares of a payment received from the known guarantor to the at least first and second billing systems as determined by the rule engine and the insurance payment posting program allocates shares based on the coverage data provided by the insurance company.

7. The medical billing system as defined in claim 1, further comprising an insurance billing program for providing a separate bill from each of the at least first and second billing systems to an insurance provider based on the coverage data.

8. The medical billing program as defined in claim 1, wherein the enterprise registration system places the guarantor in a queue for billing when charges are incurred against an account in the name of the guarantor.

9. The medical billing program as defined in claim 1, wherein the rules are configurable by a user.

10. A medical billing system for a medical enterprise comprising at least two medical practices having independent billing computer systems, the medical billing system comprising:
at least one registration computer for registering patient visits and receiving charges for the medical practices;
an enterprise computer system storing guarantor data and coverage data for the medical practices; and
at least one common data link connecting the registration computer, the independent billing computer systems, and the enterprise computer system wherein the enterprise computer system communicates with each of the registration computer and independent billing computer systems and is programmed to:
(i) receive patient identifying data and charge data from the registration computer;
(ii) associate a guarantor with the patient identifying data and charge data for each patient visit, and route appropriate charges to each of the independent billing systems;
(iii) consolidate the charges from each of the independent billing systems into a single statement for each guarantor; and
(iv) allocate a payment received from the guarantor to each of the independent billing systems based on rules provided in a rule engine.

11. The medical billing system of claim 10 wherein the enterprise registration system is further programmed to store each patient visit under a unique identifier and associate the guarantor data and the charge data with the unique identifier.

12. The medical billing system of claim 10, wherein the enterprise registration system is further programmed to route the charges received at the billing computers to the independent billing systems.

13. The medical billing system of claim 10, wherein the medical practices include at least one of a hospital and a physician office.

14. The medical billing system of claim 10, wherein each of the medical practices provides a billing statement to an insurance company and the enterprise computer system is further programmed to allocate funds from a payment from the insurance company to each of the medical practice billing systems.

15. The medical billing system of claim 10, wherein the enterprise registration system provides a data structure including a unique patient visit identifier, a guarantor for the patient visit, a coverage, and an account associated with the guarantor for each of the medical practices.

16. The medical billing system of claim 10, wherein the enterprise registration system provides a billing queue identifying the guarantors who have outstanding charges in a guarantor account.

17. The medical billing system of claim 10, wherein the enterprise computing system is further programmed to allocate a payment received from an insuring entity to at least one of the independent billing systems based on at least one of an insurance entity guideline and a configurable rule provided in a rule engine.

18. A method for producing a single statement for medical expenses incurred from at least two medical practices having independent billing computer systems, the method comprising the following steps:
identifying a guarantor for the medical charges as the charges are incurred;
associating the identified guarantor with the incurred charges and guarantor account data for each of the independent billing computer systems;
routing each charge incurred against the identified guarantor to one of the independent billing computer systems based on the type of charge;
periodically compiling a single statement for the guarantor; and
upon receipt of payment from the guarantor, allocating payment to each of the independent billing computer systems.

19. The method as recited in claim 18, further comprising the steps of associating the identified guarantor with a billing cycle queue when the charges are incurred, retrieving the identified guarantor from the billing cycle queue, and retrieving charge data from the guarantor accounts.

20. The method as recited in claim 18, further comprising the steps of associating insurance coverage data with the identified guarantor, and providing individual statements from each of the independent billing computers to the insurance provider.

21. The method as recited in claim 20, further comprising the step of collecting a single payment from the insurance provider and allocating the payment to the independent billing computers.

22. The method as recited in claim 18, further comprising the step of providing a secure interface for the guarantor to access the statement.

23. A method for producing a single statement for medical expenses incurred from at least two medical practices having independent billing computer systems, the method comprising the following steps:
providing a database identifying a guarantor for a patient and account data for the guarantor for each of the independent billing computer systems;
associating the identified guarantor with the incurred charges and guarantor account data for each of the independent billing computer systems as charges are incurred;
periodically compiling a single statement for the guarantor based on charges incurred; and
upon receipt of payment from the guarantor, allocating payment to each of the independent billing computer systems based on the type of charges incurred.

24. The method as recited in claim 23, further comprising the step of routing the charges to the independent billing computer systems after the charges are incurred, and consolidating the charges from the independent billing system computers.

25. The method as recited in claim 23, further comprising the step of automatically routing charges incurred to the independent billing computer systems based on the type of charge incurred.

26. The method as recited in claim 23, further comprising the step of allocating payment to the independent billing computers based on at least one configurable rule.
